(19) United States
(12) Patent Application Publication
(10) Pub. No.: US 2017/0091408 A1
(43) Pub. Date: Mar. 30, 2017

(54) SYSTEM AND COMPUTER IMPLEMENTED METHOD FOR COACHING A USER IN A COACHING PLAN

(71) Applicant: KONINKLIJKE PHILIPS N.V., EINDHOVEN (NL)

(72) Inventors: Murtaza Bulut, Eindhoven (NL); Jan Martijn Krans, Den Bosch (NL); Cliff Johannes Robert Hubertina Laschet, Gulpen (NL); Roger Holmes, Son en Breugel (NL); Graciana Puentes, Eindhoven (NL)

(21) Appl. No.: 15/272,954

(22) Filed: Sep. 22, 2016

(30) Foreign Application Priority Data
Sep. 29, 2015 (EP) 15187415.3

(51) Int. Cl. G06F 19/00; G06F 3/16

(52) U.S. Cl. CPC G06F 19/3418; G06F 3/16; G06F 19/345

(57) ABSTRACT

Various embodiments described herein relate to a system, method, and medium for coaching a user including one or more of the following: a plurality of instructions including variations of a reminder message to perform an action, wherein at least two of the instructions are stored in at least a first and a second delivery format; a physiological sensor for monitoring a physiological parameter of the user; and a processor unit configured to carry out the steps of: providing a first instruction from the plurality of instructions in the first delivery format; determining a level of compliance towards the goal based on the monitored physiological parameter; selecting a second instruction from the plurality of instructions based on the level of compliance towards the goal, wherein the second instruction is in either the first or the second delivery format, and is reduced in instruction content compared to the first instruction.

### TECHNICAL FIELD

Various embodiments described herein relate to a system and a computer implemented method to provide reminder instructions to the user in order to coach a user in achieving a goal of a coaching plan.

### BACKGROUND

Research has shown that a large number of the top health problems in society are either caused in whole or in part by an unhealthy lifestyle. The unhealthy lifestyle often results in poor eating habits, high stress levels, and lack of exercise, poor sleep habits, etc. Individuals in today's fast pace life have also started recognizing this fact, and are becoming increasingly interested in establishing a healthier lifestyle.

One of the prominent ways these days is to enroll in online health coaching programs for maintaining healthy lifestyle. The health coaching programs typically establish a goal and advice the user based on his progress towards the goal. However, in many cases, it is observed that the users remain motivated in the initial stage of the health program but later get disinterested and stop following the advice provided by the online health coaching programs.

### SUMMARY

One of the chief reasons for decreased motivation in following a health coaching program stems from repetitiveness of the content of the message/advice. Users after sometimes get annoyed by repeatedly receiving the same message and at some point time stop responding to the messages. Thus, the program overall becomes ineffective.

Various embodiments are described herein with an aim to provide an improved system and a computer implemented method for coaching a user while keeping delivered content fresh, even if the overall message to be conveyed in repetitive. The system and computer implemented method thus interact with the user such that the user remains motivated while being enrolled in a coaching plan.

According to various embodiments, a system for coaching a user comprising: an interface for receiving a goal of a coaching plan; a storage unit comprising a plurality of instructions, the plurality of the instructions including variations of a reminder message for the user to perform an action for achieving the goal, wherein at least two of the plurality of instructions are stored in at least a first and a second delivery format; at least one physiological sensor for monitoring a physiological parameter of the user; an output unit; and a processing unit configured to carry out the steps of: providing a first instruction from the plurality of instructions in the first delivery format to the output unit; determining a level of compliance towards the goal based on the monitored physiological parameter; subsequent to providing the first instruction, selecting a second instruction from the plurality of instructions based on the level of compliance towards the goal, wherein the second instruction is in either the first delivery format or the second delivery format, wherein the second instruction is reduced in instruction content in comparison to the first instruction, and providing the second instruction to the output unit. Various examples of delivery formats include but are not limited to one of a visual, i.e. text, image, video; audio; light and tactile.

Embodiments of the proposed coaching system described herein may provide numerous advantages. Firstly, in some embodiments, the coaching system actively reminds the user to perform an action related to the goal. Secondly, in some embodiments, the system also takes care that if the person is performing well, the instruction changes so as to be user friendly and less annoying. One can imagine if the same messages are provided to the user, over time, the user will get bored and start ignoring the messages. In contrast, the current proposed system aims to actively remind the user of the action that he needs to take to achieve a particular goal. Accordingly, various embodiments provide the same message corresponding to the achieving a particular goal, however, to change only the instruction content by means of different instructions as the user positively progresses towards the goal. Thus, the system starts with an instruction in a first delivery format, such as a text message, and with particular instruction content, such as “Take stairs when you reach office”. Thereafter, if the system determines that the user took stairs from his monitored physiological parameter information, then the system provides a second instruction, such as “Take Stairs”. In this way, the system aims to provide the same message to the user but in form of different instructions, thereby enabling the system to be user friendly and not leading to monotony over a period of time.

In a further embodiment, when the first delivery format is a text instruction format, the processing unit selects the first instruction that includes more text characters than the second instruction. It may be apparent to a person skilled in the art that having more text characters in the text is indicative of increased instruction content.

In a further embodiment, when the first delivery format is a text instruction format, the second delivery format is an audio format, wherein the audio instruction format is an alert signal. In the current advantageous embodiment, when the user progress towards goal is above a pre-determined satisfactory level, then the processor selects an audio format instruction corresponding to the same message. Following the previous example, the processing unit determines that the user has been following the previous instructions, measured by the physiological parameter information, and then the processing unit provides an audio instruction, such as a “Beep”. It should be clear to a person skilled in the art that a “Beep” (alert signal) is reduced in instruction content when compared with a meaningful text instruction.

In a further embodiment, when the first delivery format is a video or audio instruction format, the processing unit provides the first instruction that includes more time duration than the second instruction. It may be apparent to a person skilled in the art that having more duration in video or audio instruction is indicative of increased video or audio instruction content.

In a further embodiment, when the first delivery format is an image instruction format, the processing unit provides the first instruction that includes more graphical characters than the second instruction. For instance, the first image instruction may include an office building, stairs, reception desk, etc. The second image instruction may include only office building and stairs, and the third instruction image may include only stairs.

In a further embodiment, the system further includes a contextual sensor for monitoring one or more contextual parameters associated with the user, wherein the processor selects and issues the first and/or the second instruction based on the one or more monitored contextual parameters. Including a contextual sensor is in particular is advantageous as it aids in providing the instruction at the right time. Following the previous example, the user is being instructed to “take stairs to the office”. However, the message will have higher chances of creating an impact when the message is in fact provided when he has arrived at the office building. Thus, based on the location information provided by a GPS sensor, or indoor localization sensors, can aid processor in providing the message when he has reached near the office building. In another embodiment, the contextual information may further be used to select the first and/or the second instruction of appropriate delivery format. For instance, the user is detected to be in a noisy environment and hence the message such as an audio format instruction will not be provided to the user.

In a further embodiment, the processing unit is further configured to select the second instruction based on a current physiological state, also may be referred to as psycho-physiological state, of the user, the current physiological state being determined based on the physiological parameter. Following the above example, the system can monitor the physiological state to further provide the reminder message and/or feedback at the right time. The physiological state can be expressed in terms of affective dimensions, such as arousal, valence, and dominance or in terms of basic emotion, such as happiness, sadness, surprise, fear, disgust, anger. For instance, the person is at the moment very tense and thus the provided instruction might not be followed and thus, the processing unit can delay the second instruction accordingly. For instance, an exemplary rule can be if the determined stress/arousal is above a pre-determined threshold stress, then provide an instruction. The physiological state can be determined by sensors, such as heart rate sensors that measure heart rate variability or blood pressure sensor to further ascertain stress/arousal levels. The physiological state can be further determined by measuring skin conduction with the help of galvanic skin conductance sensors.

In a further embodiment, the storage unit stores a feedback message, the feedback message being indicative of accomplishment of the action, the feedback message being stored in at least one delivery format, whereby the processor unit is configured to output the feedback message in the at least one format in response of a detection of the accomplishment. The feedback messages can be seen as reward/congratulatory messages. These are provided to the user when the user has accomplished a particular goal and/or a particular action to achieve the goal.

In a further embodiment, the feedback message can also be indicative of also actual level of performance based on the level of compliance. For instance, though the user performed the action as per the instruction, thus theoretically accomplishing the action, however, he did not follow instruction as per the requirements. To cater to such a situation, the feedback message may further provide the user indications about his actual performance. To further elaborate, the user may have been asked to maintain a particular pace. In this case, though the user might have followed the instruction but might not have maintained the pace at a particular level as suggested. Thus, in this case, the feedback message may include a text such as “You did a decent job, but you had pace of X instead of Y, please maintain pace at X level the next time”. Alternatively, the feedback message can also be in form of messages that are not rewarding in nature. For instance, “you did not follow the instructions for the last 5 days; by this rate you will not be able to achieve your goal”.

In a further embodiment, the processing unit is configured to select the feedback message based on the level of compliance and to issue the feedback message via the output unit, wherein the delivery format of the feedback message is further selected based on at least one of the delivery formats of the first or the second instruction, physiological parameters associated with the user, the physiological state of the user, the contextual parameters associated with the user, and the at least one delivery format of any previously selected feedback message. Given that inventors want the system to be more user-friendly, selection as described above further aids in the motivation of the user. For instance, the user has received a text instruction; hence, providing a feedback message in text format may not be as impactful. Thus, it may be impactful to provide an audio sound of “clapping”. Of course, the selection of the feedback message can be further based on contextual information, such as noise, in a meeting, etc. and/or physiological state of the user. It may be apparent to a person skilled in the art that such various combinations are possible and can be implemented with standard classification algorithms such as Support Vector Machine, Random trees, and/or Deep Neural Networks.

In a further embodiment, the storage unit stores a plurality of instructions corresponding to the reminder message in a table, wherein the instructions are stored corresponding to a pre-defined level of compliance, wherein the processor is configured to check the calculated level of compliance with the pre-defined level of compliance to select an instruction corresponding to the reminder message. In an embodiment, the pre-defined level of compliance is pre-determined by an expert and/or medical practitioner. In an embodiment, the pre-defined level of compliance is a pre-determined numerical value, such as no of days the user needs to follow an instruction, steps counts value, calorie expenditure value, mean Heart rate value in a particular cardio zone, percentage of change in a particular parameter, etc.

In another embodiment, the pre-defined level of compliance can be determined based on a mathematical function. An example of the mathematical function could be related to the percentage number of times the person followed the instruction. In yet another embodiment, the pre-defined level of compliance can be determined based on distribution of the data. To further elaborate, based on the physiological data that is received over a period of time data can be further divided into week 1 data and week 2 data. Thereafter, distribution of the physiological data can indicate the trend of the compliance. For instance, increased mean of the heart rate data in week 2 over week 1 can indicate that the person regularly followed the instructions, thus change in mean can be used to determine the pre-defined level of compliance.

In a further embodiment, the processing unit is configured to stop providing an instruction when the calculated level of compliance matches a pre-defined level of compliance. As discussed earlier, one aim of embodiments described herein is to provide a user friendly system that is less annoying. Thus, if the system determines that the person has been regularly following the instructions so far in the past, then the system will stop providing instruction at some point in time. For instance, the system can have a pre-defined maximum threshold indicating maximum number of times instructions are sent to the person. If such a threshold is reached, the system can stop sending further instructions. It is understood by the inventors, that if the person performs a particular action for a pre-defined number of times, then it becomes a habit and thus he need not require any further instructing from the system.

In a further embodiment, the processing unit is configured to select at least one instruction of the plurality of instructions when a new calculated level of compliance is below the calculated level of compliance, wherein the at least one instruction is one of the first and the second instruction. Following the above example, when the person stops performing an action, the system will reconvene to providing the instructions. Thus, when the system stops providing instructions, it still continues to monitor the physiological parameter information and provides the instruction again if the monitored level of compliance falls below the pre-determined maximum threshold. The system can start with the last instruction content that was provided to the user before stopping or can select one of the instructions from the plurality of instructions. It may be apparent to a person skilled in the art that various rules can be programmed in the system such that system can thus select an appropriate instruction accordingly. These rules can include variables, such as context information, physiological state information, time of the day, etc.

In an embodiment, the system as disclosed above can be embodied in a wearable device, such as a wrist watch, a chest strap including a physiological sensor, or a wireless communication device along with a strap to conform to the body part of the user.

In another embodiment, the system can be implemented with a combination of a wireless communication device and a wearable device. In yet another embodiment, the system can be implemented with a remote server and a wearable device and/or a wireless communication device, wherein the remote server may select the messages to be displayed onto the wearable device and/or the wireless communication device.

According to various embodiments, a computer implemented method is provided for coaching a user. The computer implemented method includes receiving a goal associated with a coaching plan; providing a first instruction in a first delivery format, wherein the first instruction is selected from a plurality of the instruction stored in at least one of the first and a second delivery format in a storage unit, the plurality of the instructions including variations of a reminder message for the user to perform an action for achieving the goal; determining a level of compliance towards the goal, wherein the level compliance is determined based on at least one physiological parameter associated with the user, the at least one physiological parameter being detected by a physiological sensor; and subsequent to providing the first instruction, providing a second instruction from the plurality of instructions based on the level of compliance towards the goal, wherein the second instruction is in either the first delivery format or the second delivery format, wherein the second instruction is reduced in instruction content in comparison to the first instruction.

According to various embodiments, a computer program product including the computer implemented method as described above is provided. There are provided a computer program which comprises program code means for causing a computer to perform the steps of the method disclosed herein when said computer program is carried out on a computer as well as a non-transitory computer-readable recording medium that stores therein a computer program product, which, when executed by a processor, causes the method disclosed herein to be performed.

It shall be understood that the claimed computer implemented method, computer program product have similar and/or identical preferred embodiments as the claimed system for coaching a user to achieve a goal in a coaching plan.

### BRIEF DESCRIPTION OF THE DRAWINGS

These and other aspects of the computer implemented method, system and computer program product will be apparent from and elucidated with reference to the implementations and embodiments described hereinafter, and with reference to the accompanying drawings, which serve merely as non-limiting specific illustrations exemplifying the more general concept.

FIG. 1a and FIG. 1b show a flow chart depicting overall method for coaching a user, according to an embodiment; and

FIG. 2 shows a system for a coaching a user, according to an embodiment.

### DETAILED DESCRIPTION

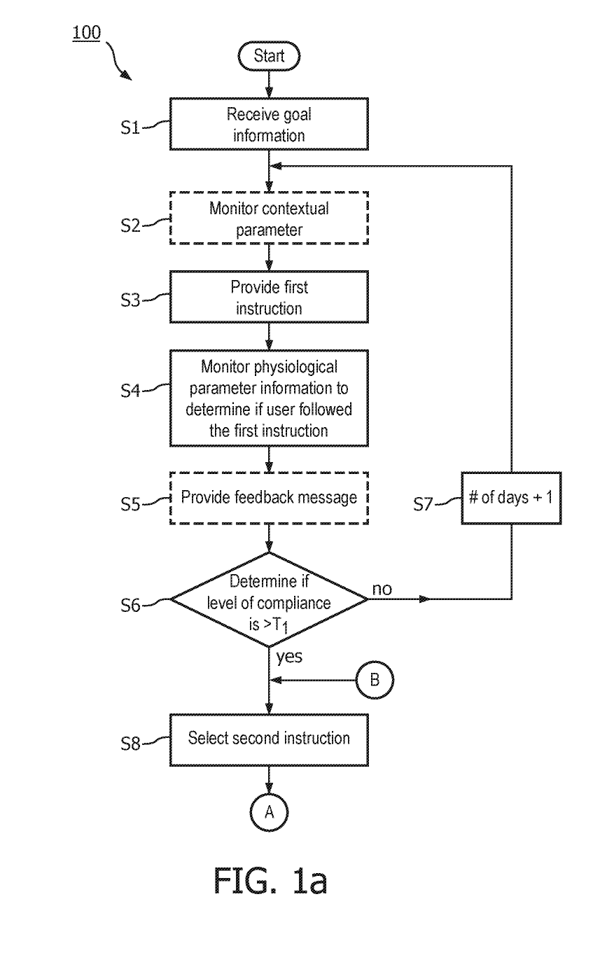

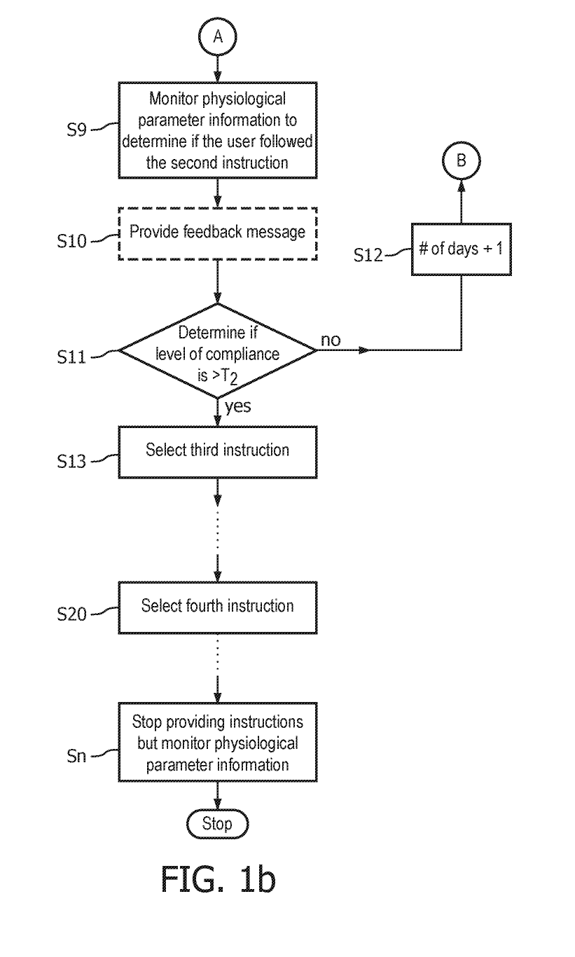

FIG. 1a and FIG. 1b show a flow chart 100 for coaching a user according an embodiment.

Prior to explaining the various embodiments, certain terminologies used throughout the draft are explained below for the sake of clarity.

Coaching Plan: The coaching plan can elucidated as a fitness regime that a user should follow in order to stay active and fit.

Goal: The goal can be elucidated as a target that the user must achieve in order to remain fit. For instance, the goal can be that person must take stairs to the office every day in order to remain fit. Goal can be further divided into pre-defined time intervals in order to monitor the progress of the user towards the goal. The goal can be defined as a target value. For instance number of days the user has to take stairs. Various other examples of the target value can be provided in order to monitor the progress. For instance, number of steps, calorie expenditure, etc. Following the example of calorie expenditure, the goal can be further divided such that the user is asked to achieve a certain target in a first week and a second target in a second week and so on. It is important that goals are further divided as it is easier to monitor user's progress on a timely basis.

Message: The message in the current context of various embodiments is a reminder to perform an action in order to achieve the goal. For instance, take stairs to the office every day. Thus, the message can also be termed as the reminder message.

Instruction: The instruction is a variation of the reminder message. Thus, it has to be appreciated by a person skilled in the art that the message remains the same but only instructions change as the user progresses towards the goal. Various instructions are listed in Table 1 below.

Feedback Message: The feedback message is a form of a congratulatory message provided to the user when he follows an instruction. In other words, the feedback message is provided upon completion of the action. Various feedback messages are listed in Table 1 below.

The method, as will be explained in detail below, selects a right/appropriate instruction corresponding to a message for the user. These instructions, in this embodiment, are stored in the Table. Table 1 shows a progression of the instructions and the feedback message, according to some embodiments. It will be understood that, in various embodiments, additional tables similar to Table 1 may be stored for defining additional groups of instructions that correspond to additional messages.

TABLE 1

| | | | Pre-determined | | |
|---|---|---|---|---|---|
| | | Instruction/ | Thresholds (T) to | | Feedback |
| | Instruction | Delivery | check level of | Feedback | Delivery |
| Instruction # | Content | Format | Compliance | Message | Format |
| 1 | Take Stairs to | Text | T1: First 7 days | Well done | Text |
| | office Today | Message | | | |
| 2 | Take Stairs | Text | T2: Subsequent | Claps | Audio |
| | | Message | 5 days | | |
| 3 | Stairs | Text | T3: Subsequent | Claps | Image |
| | | Message | 3 days | | |
| 4 | Beep | Audio | T4: Subsequent | You are | Text |
| | | | 3 days | doing really | |
| | | | | well | |

The method starts at S1 by receiving goal information. In the current example the goal can be to take stairs to office for continuous 18 days. In an embodiment, the goal can be pre-determined by a fitness instructor, the user, a separate coaching algorithm, etc.

At S2, the method monitors contextual parameter associated with the user. In an embodiment, the contextual parameter is location. Various examples of the contextual parameters include but are not limited to a sound, calendar information to indicate if the user is busy/available, ambient light information, listening to music, indoor positioning, such as iBeacon®, weather information, etc.

At S3, the method provides a first instruction at the start of the fitness regime/health program/coaching plan. In the current example, the first instruction is “take stairs to the office today.” Further, the instruction is in form of a text message that can be outputted on a screen of a wearable device and/or a wireless communication device of the user. Though in the current example the first instruction is provided in text format, the first instruction in an alternate embodiment can be also provided in an audio format. Given that the instruction is in the audio format, further characteristics, such as tone of the instruction (commanding, soothing) and volume of the instruction (high, medium and low) can further be added to the message to increase the effect on the user. In an advantageous embodiment, the method provides the first instruction based on the contextual information received from at least one contextual sensor associated with the user. In the current examples, the contextual sensor is a GPS sensor and the method provides the first instruction as soon it is determined the user is near his office building. In an alternate embodiment, the method can provide the first instruction without the contextual information and hence the instruction can be provided at a fixed time in the day or the timing of providing the instruction can be random.

At S4, the method monitors the physiological parameter information of the user. In the current case, the physiological parameter information is count of stairs taken. Stairs count is used to check if the user indeed followed the instruction. In other words, the effectiveness of the instruction is directly measured by the action performed, such as taking stairs, by the user. In an embodiment, an accelerometer can be used to monitor if the user took stairs. Further, in the advantageous embodiment, the accelerometer is housed in the wearable device and/or wireless communication device of the user. It will be understood that different physiological parameter information may be monitored in S4 in different contexts such as, for example, for different goals received in S1. In some embodiments, the table associated with the goal or message may define the physiological parameter information to be monitored and the metric considered to correspond to successful performance of the action (e.g., in the form of a comparison/conditional statement).

At S5, a feedback message is sent to the user if he performs the action, as determined by the monitored physiological parameter information. As mentioned earlier, the determination of the completion of the action is derived based on the physiological parameter information. The feedback message is sent in order to congratulate or inform the user upon following of the instruction. The method further provides the feedback message in a delivery format, such as text, audio, etc. based on at least one of the delivery formats of the first instruction, physiological parameter, and/or contextual parameter associated with the user. In the current example, the feedback message is “Well done” and in text format. In some advantageous embodiments, various rules can be defined such that it can further be checked to send a feedback message in a delivery format based on contextual parameter information and/or physiological parameter information and/or delivery format of the first instruction. For instance, in an example, if it is determined that person is a noisy place, then an audio delivery format is not used. Alternatively, the timing of the message can be delayed. Similarly, if it is also determined that the person is in a stressed state (physiological state derived from the physiological parameter), then either message can be delayed or a suitable audio delivery format message, such as sound of claps, can be provided to the user.

At S6, the method determines if level of compliance is greater than a pre-determined first threshold. In the current example, the first pre-determined threshold (T1) can be set to 7 days and the level of compliance, i.e. did the user take stairs on day 1, day 2, day 3, etc. If it is determined that the user did take the stairs today and yet has not taken the stairs for the first 7 days, then the method continues to provide the same instruction, i.e. the first instruction, till he take stairs for the 7 days continuously. In parallel the method keeps counting and storing the number of days (S7). The first instruction may be provided once a day. It is clear that in different embodiments, the first instruction can be provided several times in a day.

However, at S6, once it is determined that the person did take stairs for the first seven days, the method progresses to S8 in order to select a second instruction for the eighth day. The second instruction in the current example is “Take Stairs”. The message is in form of a text message and is provided to the user via a wearable device and/or the wireless communication device. It may be appreciated by a person skilled in the art that the instruction content is changed as the person is progressing towards the goal. In the current case, since the user has already followed the instructions for first seven days, he has already made a progress towards the end goal, which was in this case set to 18 days. Thus, to keep the user interactivity interesting, the method provides a more compact instruction to the user. While providing the second instruction to the user, as described earlier, the contextual information can be again used to increase the likelihood of the success of the instruction to be followed.

After providing the second instruction, the method monitors physiological parameter information, i.e. taking the stairs information, at S9. As described in S5, a similar feedback message in a suitable delivery format is outputted to the user at S10 upon following the second instruction. Thereafter, it is again determined at S11, if second level of compliance is greater than the second pre-determined threshold (T2). In this case the second pre-determined threshold is 5 days. Thus, at S11, it is checked for each day after the 5th day, i.e. 6^{th} day, 7^{th} day, etc., whether the user took the stairs. Thus, if it is determined at S11 that the user did takes stairs for the consecutive five subsequent days based on incrementing the number of days at S12; the method selects a third instruction “stairs” at S12 in form of a text message to be provided to the user. This method will continue to monitor the level of compliance as explained above till all the instruction options are exhausted. In the current example, after it is determined that the person completed the action, i.e. taking stairs, for the subsequent 3 days (T3), the method finally provides an audio beep (an alert signal) at S20 to the user for another subsequent number of days (T4). In an embodiment, the method at Sn keeps monitoring the physiological parameter of the user after the user has performed an action as per the goal requirements, in this case 18 days to take stairs to office, and does not provide any further instruction. In the advantageous embodiment, if the method determines that the user is not performing the action anymore and is getting back to his previous habit, then the method restarts to send one of the instructions from the set of instructions from the Table 1. In an embodiment, the method can start with sending the last sent instruction, i.e. audio beep, to remind him again. In another embodiment, the selection of the instruction from the set of instructions can be random. In a further embodiment, such a determination can be performed in middle of the coaching plan and not necessarily at the end of the program. For instance, the user religiously followed the first and the second instruction, however, he started to slack/get lazy later, the method can again go back to last known instruction provided to the user and can further go back to the first instruction. Thus, this can be seen as the case wherein instruction content can be increased if the person is not progressing towards the goal.

Various alternative algorithms for selecting an appropriate instruction from a group based on compliance will be apparent. For example, in various alternative embodiments, rather than having an explicit “stage” in the algorithm for each threshold (e.g., steps S8-S12 as separate instructions from steps S3-S7), a single loop may be used to select an appropriate instruction by identifying, in each iteration, the highest threshold crossed by the level of compliance and then sending the instruction associated with that threshold.

In yet another embodiment, there can be various tables such as Table 1 with different progression length in the instructions with different pre-defined thresholds. This is further elaborated with Table 2 below.

| | | | Pre-determined | | |
|---|---|---|---|---|---|
| | | Instruction/ | Thresholds (T) to | | Feedback |
| | Instruction | Delivery | check level of | Feedback | Delivery |
| Instruction # | Content | Format | Compliance | Message | Format |
| 1 | Take Stairs to | Text Message | T1: First 7 days, | You are | Text |
| | office Today | | however, the user | doing good | |
| | | | makes to 7 days | | |
| | | | not in 7 | | |
| | | | consecutive days | | |
| | | | but with 2 | | |
| | | | intermittent | | |
| | | | misses. | | |
| 2 | Take Stairs to | Text Message | T2: Subsequent 7 | Claps | Audio |
| | office | | days | | |
| 3 | Take Stairs | Text Message | T3: Subsequent 5 | Claps | Image |
| | | | days | | |
| 4 | Stairs | Text Message | T4: Subsequent 3 | You are | Text |
| | | | days | doing really | |
| | | | | well | |
| 5 | Beep | Audio | T5: Subsequent 3 | Jubilee | Audio |
| | | | days | Music | |

As it can be seen that progression length of the instruction, i.e. number of instructions, is increased to five types of instructions when compared to progression length in Table 1 that includes four types of instructions. In an alternate example, the method can start with the same instruction at the start of the coaching plan. However, the method can further cater to how the user is progressing towards the goal and accordingly select a different progression length and path of the messages. For instance, if the method determines that the user did follow the instruction and did take stairs seven days, however, these were not each day but based on nine daily instructions, then the method selects a longer progression path of instructions. Though, in Table 2, instructions 2, 3, 4, and 5 are straight forward, one can imagine that similar rules as instruction 1 can be included and method can be further made dynamic to select one of the instructions that are lesser in instruction content than the previous instruction.

In a further embodiment, in addition to providing an instruction based on the physiological parameter information and contextual parameter information, the method further provides the instruction based on physiological state of the user. For instance, the method determines that the person is near the office and he needs to take the stairs, however, his physiological state derived from the monitored physiological parameters, such as heart rate, heart rate variability, skin conductance, body movements, speech, etc. indicates that he is stressed; the method may accordingly delay the delivery of the instruction. In an alternate embodiment, the physiological state of the user can be also monitored based on his speech (using microphone) and gestures and/or gait (using a standard camera).

The method steps depicted within dotted lines in the flowchart are optional steps. For instance, steps S2, S5, and S10. It may be appreciated that these steps form alternate embodiments. Furthermore, these steps help to improve the overall selection and providing of the instructions.

Though in the above method, the instructions are provided in a sequence, it is also possible in an alternate embodiment that the method selects instruction 3 instead of instruction 2 after the instruction 1. In an embodiment, the method may select to skip one or more of the instructions in the sequence based on various parameters, such as level of compliance, contextual parameter information, physiological state information, delivery format, etc.

The method in various embodiments above accommodates various constraints/variables such as the contextual information, the physiological state information, delivery format of the instructions, etc. The method can be trained using the standard classification algorithms such as Support Vector machines, Random trees or Deep Neural Networks.

The method as described above is embodied as a computer implemented method in which a computer or programmable processor is used which executes a computer readable program. Further the computer readable program is embodied in a computer program product, such as random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), and an electrically erasable programmable read-only memory (EEPROM), another like memory device. The computer program product can also be an application (app) that can be installed on a computer/a wireless communication device/a portable electronic device/wearable device. As used herein, the term “non-transitory machine-readable medium” will be understood to encompass all such computer program products including volatile and non-volatile memories, but to exclude transitory signals.

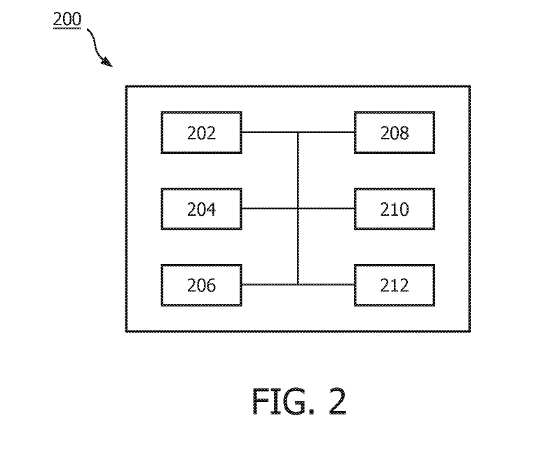

FIG. 2 shows a system 200 for coaching a user, according to an embodiment. The system 200 includes an interface 202, a storage unit 204, a physiological sensor 206, an output unit 208, a contextual sensor 210 and a processing unit 212.

In an embodiment, the system 200 is embodied in a wearable device (not shown in the figures). Various examples of the wearable device include but are not limited to a wrist watch, such as Philips® Health Watch device, Apple Watch® and mio Alpha®, and Google Glass®, a wireless communication device configured to be wrapped around a body part of the user using a strap.

The interface 202 is configured for receiving a goal of a coaching plan. In an embodiment, the interface 202 is a Graphical User Interface (GUI). Another embodiment, the interface 202 can be an input port, such as micro USB, to receive information through another computing entity, such as a server, an application (app) installed on a wireless communication device, a browser running on a client device such a computer of the user/health practitioner. In yet another embodiment, the interface 202 can be wireless receiver of the system 200, such as wearable device, to receive the goal information from remotely located health practitioner, the user. In some embodiments, the interface 202 may include a wired or wireless network interface for receiving the goal or other information from other local or remote devices. In yet another embodiment, the interface 202 can be push buttons and/or touch interface on the wearable device. In yet another embodiment, interface 202 can be a combination of software and hardware components of the wearable device.

The storage unit 204 stores a plurality of instructions, the plurality of the instructions including variations of a reminder message for the user to perform an action for achieving the goal, wherein at least two of the plurality of instructions are stored in at least a first and a second delivery format.

The storage unit 204 may include both volatile and/or nonvolatile memory and data storage components. Volatile components are those that do not retain data values upon loss of power. Nonvolatile components are those that retain data upon a loss of power. Thus, the memory may include, for example, random access memory (RAM), read-only memory (ROM), hard disk drives, solid-state drives, and/or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), and an electrically erasable programmable read-only memory (EEPROM), another like memory device. The storage unit 204 is a computer readable medium.

The physiological sensor 206 is configured for monitoring a physiological parameter of the user. In an embodiment, the physiological sensor 206 is an accelerometer, such 3-axis accelerometer. Various other physiological sensors 206 can be used based on the type of physiological information that needs to be measured based on the user preferences. Few examples include but are not limited to a pulse rate sensor, a breathing sensor, O2 sensor, speed sensor, power/intensity sensor. In an embodiment, more than one physiological sensor 206, such as mentioned above in any combination, can be used. The user can select via the interface 202 the type of goal to be monitored and accordingly the corresponding physiological sensor 206 is used. For instance, for goal corresponding to calorie expenditure may require more than one sensor, such as a combination of a heart rate sensor and accelerometer.

The system 200 further includes the output unit 208. The output unit 208 is configured to output the first and/or second instruction to the user. In an embodiment output unit 200 is a display unit (not depicted in figures) on the wearable device and also an audio output device, such as a speaker (not depicted in figures). The display unit may further display instruction in form of a text message, video message, image, etc. Various other examples of the output unit 208 include but are not limited to a vibration producing unit, light flashing unit, etc.

The system 200 also includes a contextual sensor 210. The contextual sensor 210 is configured for monitoring contextual information associated with the user. In an embodiment, the contextual sensor 210 is a GPS sensor. Various other examples of the contextual sensor 210 include but are not limited to ambient sound and/or light sensor, activity monitors, software modules configured to derive contextual information from calendar, status of the user on various social networking site, time of the day, iBeacons®, CO2 level, air pollution, temperature, etc.

The processing unit 212 is configured for providing first and/or the second instruction to the user based on the level of compliance. The processing unit executes the method steps S1-Sn as described in FIG. 1. It may be apparent to the person skilled in the art that the processing unit 212 interacts with various modules of system 200 to execute the method steps S1-Sn. In an embodiment, the storage unit 206 may store instructions (S1-Sn) that are executable by the processing unit 212 for selection and providing of the instructions to the user.

The term processing unit, as used herein, may be any type of controller or processor, and may be embodied as one or more controllers or processors adapted to perform the functionality discussed herein. Additionally, as the term processor is used herein, a processor may include use of a single integrated circuit (IC), or may include use of a plurality of integrated circuits or other components connected, arranged or grouped together, such as controllers, microprocessors, digital signal processors, parallel processors, multiple core processors, custom ICs, application specific integrated circuits, field programmable gate arrays, adaptive computing ICs, associated memory, such as and without limitation, RAM, DRAM and ROM, and other ICs and components.

In another embodiment, the system 200 can be split in one or more system modules interacting with each other, for instance, a combination of a wearable device(s) (not depicted in figures) and a wireless communication device(s)(not depicted in figures) interacting with each other over a wireless network. The wearable device may include the physiological sensor 206, while rest of the modules, such the interface 202, the storage unit 204, the output unit 208, the contextual sensor 210 and the processing unit 212 are included in the wireless communication device. Yet another embodiment is possible, wherein the output unit 208 of both the devices, i.e. the wearable device and the wireless communication device can provide the instructions simultaneously. Similarly, another possibility is of a combination of the wearable device (not depicted in the figures) and a remote server (not depicted in figures) of the coaching service provider interacting with each other over the wireless network. In this configuration for instance, the wearable device may include the physiological sensor 206, the interface 202, the output unit 208, and the contextual sensor 210, while the processing capabilities to select and provide the instructions stored in the storage unit 204 are included in the remote server of the coaching service provider. Various examples of the wireless network include but are not limited to the Internet, intranets, extranets, wired networks, wireless networks, wide area networks (WANs), local area networks (LANs), or other suitable networks, etc., or any combination of two or more such networks. Various examples of wireless communication device include but are not limited to a mobile device, a cellular telephone, a smart phone, a music player, a web pad, a tablet computer system, or other devices with like capability.

It will be clear to a person skilled in the art that the scope of the present disclosure is not limited to the examples discussed in the foregoing, but that several amendments and modifications thereof are possible without deviating from the scope of the attached claims. While various embodiments have been illustrated and described in detail in the figures and the description, such illustration and description are to be considered illustrative or exemplary only, and not restrictive. The claims are not limited to the disclosed embodiments.

Variations to the disclosed embodiments can be understood and effected by a person skilled in the art in practicing the subject matter recited in the claims, from a study of the figures, the description and the attached claims. In the claims, the word “comprising” does not exclude other steps or elements, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope thereof.

A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. A system for coaching a user comprising:
a. an interface for receiving a goal of a coaching plan;
b. a storage unit comprising a plurality of instructions, the plurality of the instructions including variations of a reminder message for the user to perform an action for achieving the goal, wherein at least two of the plurality of instructions are stored in at least a first and a second delivery format;
c. at least one physiological sensor for monitoring a physiological parameter of the user;
d. an output unit; and
e. a processing unit configured to carry out the steps of:
i. providing a first instruction from the plurality of instructions in the first delivery format to the output unit,
ii. determining a level of compliance towards the goal based on the monitored physiological parameter, and
iii. subsequent to providing the first instruction, selecting a second instruction from the plurality of instructions based on the level of compliance towards the goal, wherein the second instruction is in either the first delivery format or the second delivery format, wherein the second instruction is reduced in instruction content in comparison to the first instruction, and providing the second instruction to the output unit.

2. The system according to claim 1, wherein the first delivery format is a text instruction format, wherein the first instruction includes more text characters than the second instruction.

3. The system according to claim 1, wherein the first delivery format is a text instruction format and the second delivery format is an audio instruction format, wherein the audio instruction format is an alert signal.

4. The system according to claim 1, wherein the first delivery format is a video/audio instruction format, wherein the first instruction includes instruction content for longer duration of time than the second instruction.

5. The system according to claim 1, wherein the first delivery format is an image instruction format, wherein the first instruction includes more graphical characters than the second instruction.

6. The system according to claim 1 further comprising a contextual sensor for monitoring one or more contextual parameters associated with the user, wherein the processor selects and issues the first and/or the second instruction based on the one or more monitored contextual parameters.

7. The system according to claim 1, wherein the processing unit is further configured to select the second instruction based on a current physiological state of the user, the current physiological state being determined based on the physiological parameter.

8. The system according to claim 1, wherein the storage unit is further configured to store a feedback message, the feedback message being indicative of accomplishment of the action, the feedback message being stored in at least one delivery format, whereby the processor unit is configured to output the feedback message in the at least one delivery format in response of a detection of the accomplishment, the accomplishment of the action being detected being based on the level of compliance.

9. The system according to claim 1, wherein the processing unit is further configured to select the feedback message based on the level of compliance and to issue the feedback message via the output unit, wherein the delivery format of the feedback message is further selected based on at least one of the delivery formats of the first or the second instruction, physiological parameters associated with the user, the physiological state of the user, the contextual parameters associated with the user, and the at least one delivery format of any previously selected feedback message.

10. The system according to claim 1, wherein the delivery format is one of a visual, audio and tactile format.

11. The system according to claim 1, wherein the storage unit stores a plurality of instructions corresponding to the reminder message in a table, wherein the instructions are stored corresponding to a pre-defined level of compliance, wherein the processor is configured to check the calculated level of compliance with the pre-defined level of compliance to select an instruction corresponding to the message.

12. The system according to claim 1, wherein the processing unit is further configured to stop issuing an instruction when the calculated level of compliance matches a pre-defined level of compliance.

13. The system according to claim 12, wherein the processing unit is further configured to select at least one instruction of the plurality of instructions when a new calculated level of compliance is below the calculated level of compliance, wherein the at least one instruction is one of the first and the second instruction.

14. A computer implemented method for coaching a user comprising:
receiving a goal associated with a coaching plan;
providing a first instruction in a first delivery format, wherein the first instruction is selected from a plurality of the instruction stored in at least one of the first and a second delivery format in a storage unit, the plurality of the instructions including variations of a reminder message for the user to perform an action for achieving the goal;
determining a level of compliance towards the goal, wherein the level compliance is determined based on at least one physiological parameter associated with the user, the at least one physiological parameter being detected by a physiological sensor; and
subsequent to providing the first instruction, providing a second instruction from the plurality of instructions based on the level of compliance towards the goal, wherein the second instruction is in either the first delivery format or the second delivery format, wherein the second instruction is reduced in instruction content in comparison to the first instruction.

15. A non-transitory machine-readable medium encoded with instructions for execution by a processor, the non-transitory machine-readable medium comprising:
instructions for determining an identification of a reminder message to be delivered to a user,
instructions for retrieving an instruction group of a plurality of instruction groups wherein:
the plurality of instruction groups are respectively associated with potential reminder messages to a user,
each instruction group of the plurality of instruction groups comprises a respective plurality of instructions associated with respective compliance levels, and
the retrieved instruction group is associated with the identified reminder message,
instructions for receiving a physiological parameter of the user,
instructions for identifying an instruction to be delivered by comparing the physiological parameter to the compliance levels of the plurality of instructions in the retrieved instruction group, and
instructions for delivering the identified instruction to the user.

16. The non-transitory machine-readable medium of claim 15, wherein the instructions for determining an identification of a reminder message to be delivered to a user comprise instructions for receiving the identification from another device.

17. The non-transitory machine-readable medium of claim 15, wherein the instructions for identifying an instruction to be delivered by comparing the physiological parameter to the compliance levels of the plurality of instructions in the retrieved instruction group comprise:
instructions for computing a current compliance level based on the physiological parameter; and
instructions for comparing the current compliance level to at least one of the compliance levels of the plurality of instructions.

18. The non-transitory machine-readable medium of claim 17, wherein the instructions for computing a current compliance level based on the physiological parameter comprise:
instructions for determining, from the physiological parameter, whether the user followed a previously delivered instruction from the retrieved instruction group.

19. The non-transitory machine-readable medium of claim 17, wherein the retrieved instruction group includes a first instruction to be delivered according to a first delivery format and a second instruction to be delivered according to a second delivery format that is different from the first delivery format.

20. The non-transitory machine-readable medium of claim 17, wherein the compliance levels of the retrieved instruction group define a plurality of thresholds that define at least one of:
respective periods of time over which the user has followed each of a series of previously delivered instruction from the retrieved instruction group, and
respective numbers of consecutive instances over which the user has followed each of a series of previously delivered instruction from the retrieved instruction group.
